(19) United States
(12) Patent Application Publication
(10) Pub. No.: US 2012/0170739 A1
(43) Pub. Date: Jul. 5, 2012

(54) METHOD OF DIVERSIFICATION OF A ROUND FUNCTION OF AN ENCRYPTION ALGORITHM

(75) Inventors: Mohamed Karroumi, Rennes (FR); Amaëi Grevin, Paris (FR)

(73) Assignee: THOMSON LICENSING, Issy Les Moulineaux (FR)

(21) Appl. No.: 13/392,295

(22) PCT Filed: Aug. 31, 2010
(86) PCT No.: PCT/EP2010/062771

§ 371 Date: Feb. 24, 2012

(30) Foreign Application Priority Data
Sep. 8, 2009 (EP) 09305823.8
Feb. 26, 2010 (EP) 10305196.7

(51) Int. Cl. H04L 9/28

(52) U.S. Cl. 380/28

(57) ABSTRACT

A method of diversification of an iterative function of an encryption algorithm. During an iteration at least one parameter other than an encryption key and an input message is modified. It is particularly advantageous that the encryption algorithm is the Advanced Encryption Standard.

### TECHNICAL FIELD

The present invention relates generally to cryptography, and more particularly to an algorithm for encryption and/or decryption of data.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

A copy protection system intended to run on a malicious host is, by definition, prone to reverse engineering attacks because the adversary is able to view the programs execution and intermediate results generated during computation. The so-called white-box attack context was introduced as a setting where the adversary is allowed to make observations about the software and to examine or alter the software intermediate results; see S. Chow, P. Eisen, H. Johnson, P. C. van Oorschot, “A White-Box DES Implementation for DRM Application”, Digital Rights Managerment WorkShop-DRM 2002, Lecture Notes in Computer Science, vol. 2696, 2003, pp. 1-15.

In order to protect the Advanced Encryption Standard (AES) in such a context, Chow et al. implemented a white-box AES encryption algorithm; see S. Chow, P. Eisen, H. Johnson, P. C. van Oorschot, “White-Box Cryptography and an AES Implementation”, Selected Areas in Cryptography-SAC 2002, Lecture Notes in Computer Science, vol. 2595, 2003, pp. 250-270. However, Billet et al. showed that the secret key can be extracted from Chow's implementation with time complexity of 2³⁰; see O. Billet, H. Gilbert, C. Ech-Chatbi, “Cryptanalysis of a White Box AES Implementation”, Selected Areas in Cryptography-SAC 2004, Lecture Notes in Computer Science, vol. 3357, In H. Handschuh, A. Hasan (eds.), 2005, pp. 227-240.

It can therefore be appreciated that there is a need for a solution that provides a white-box version of AES that is less vulnerable to Billet's attack. The present invention provides such a solution. The skilled person will appreciate that while the invention was made for AES, it may also be used in other iterative block cipher encryption algorithms.

In order to facilitate understanding of the present invention, AES, its white-box implementation and Billet's attack will now be described.

### AES Description

AES is a standard for data encryption, at present with three versions, depending on the key length: 128 bits, 192 bits or 256 bits. The block length, i.e. the length of a basic unit of cleartext and later ciphertext, is 128 bits, and a block is represented as a (4×4) matrix of bytes, called a state. AES operates over the algebraic Galois field GF(2⁸). The reason is computational efficiency, as GF(2⁸) elements can be represented by bytes, which can be easily processed by computers. Without loss of generality, the description hereinafter will focus on the 128-bit version of AES, i.e. AES-128.

The AES-128 algorithm comprises 10 iterations, called rounds, that each performs four transformations:

SubBytes: This transformation takes the multiplicative inverse of the input in GF(2⁸) modulo the irreducible polynomial of AES x⁸+x⁴+x³+x+1, the output of which is transformed by the affine transformation:

$$[ \begin{matrix}{y}_{0} \\ {y}_{1} \\ {y}_{2} \\ {y}_{3} \\ {y}_{4} \\ {y}_{5} \\ {y}_{6} \\ {y}_{7}\end{matrix} ] ← [ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] \cdot [ \begin{matrix}{x}_{0} \\ {x}_{1} \\ {x}_{2} \\ {x}_{3} \\ {x}_{4} \\ {x}_{5} \\ {x}_{6} \\ {x}_{7}\end{matrix} ] + [ \begin{matrix}1 \\ 1 \\ 0 \\ 0 \\ 0 \\ 1 \\ 1 \\ 0\end{matrix} ]$$

ShiftRows: This transformation is a byte transposition that cyclically shifts each row of the state by respectively 0, 1, 2 and 3 positions to the left.
MixColumns: This transformation operates on the columns of the state. It is a multiplication of the column by the polynomial mc(x)=03.x³+01.x²+01.x+02 in GF(2⁸)⁴ modulo the polynomial x⁴+1. This can be described by a matrix multiplication (the matrix being denoted MC):

$$[ \begin{matrix}{x}_{0} \\ {x}_{1} \\ {x}_{2} \\ {x}_{3}\end{matrix} ] ← [ \begin{matrix}02 & 03 & 01 & 01 \\ 01 & 02 & 03 & 01 \\ 01 & 01 & 02 & 03 \\ 03 & 01 & 01 & 02\end{matrix} ] \cdot [ \begin{matrix}{x}_{0} \\ {x}_{1} \\ {x}_{2} \\ {x}_{3}\end{matrix} ]$$

AddRoundKey: This transformation is an XOR operation with the round key, i.e. the key used for the particular round.

Put another way, if Xis the state, each round consists of:
X←SubBytes(X)
X←ShiftRows(X)
X←MixColumns(X)
X←Add Round Key(XᵢKᵢ)
   where Kᵢ denotes the round key i.

The AES⁻¹ algorithm, i.e. the corresponding decryption algorithm, works in the reverse direction by using the inverses of the steps: InvSubBytes, InvShiftRows, InvMixColumns and AddRoundKey. A complete description (including test vectors) can be found in National Institute of Standards and Technology (NIST): Advanced Encryption standard (AES), FIPS Publication 197, 2001. Available at URL http://csrc.nist.gov/publications/fips/fips197/fips-197.pdf.

### White-Box Implementation

The strategy of the white-box implementation of AES, WB-AES, is to convert AES into a series of look-ups in key-dependent look-up tables and to hide the secret keys in these tables. Each table is composed of several steps of the AES and encoded with random bijections.

FIG. 1 illustrates a round of WB-AES before random bijections encoding (ShiftRows is omitted). Compared to ‘ordinary’ AES, the operations of the WB-AES rounds are slightly changed without impacting the input or the output. AddRoundKey and SubBytes of the next round are combined into one step, and the subkey (calculated using AES key schedule) is integrated into SubBytes by creating bytes input/output look-up tables ^{r}T of round r.

^{r}T_{i,j}(x)=S(x⊕^{r}K_{i,j}) r≦1, . . . ,9 i,j=0, . . . ,3

¹⁰T_{i,j}(x)=S(x⊕⁹K_{i,j})⊕¹⁰K_{i,j} i,j=0, . . . ,3 (13

where S is the AES S-box and K is the AES subkey.

MixColumns operates on the AES state one column at a time. This can be implemented by multiplying a 32×32 matrix MC (thereafter MixColumns matrix) and a 32×1 vector. Multiplication of a 32-bits vector by MC is done by four separate multiplications and three 32-bits XORs. ShiftRows is implemented by providing shifted input data to the generated tables.

WB-AES generally uses external and internal encodings. External encoding permits the shielding of the implementation:

G∘E_{K}∘F⁻¹ [symbol] F∘E_{K}⁻¹∘G⁻¹

If external encoding is applied to the encryption operation, inverse encoding should be applied to the decryption operation and vice-versa. Otherwise, decryption cannot be possible.

Internal encoding randomizes the data flow between consecutive look-up tables. For the sake of clarity, the description only considers internal encodings to give the general idea and to provide information necessary for the understanding of Billet's attack.

Let us consider AES as a composition of 10 functions as follows:

E=R₁∘R₂∘ . . . ∘R₉∘R₁₀

where Rᵢ represents the operations of an entire AES round coded as a look-up table. A table is delinearized using random permutations Pᵢ. The idea is to compose a round of AES operations by inserting a Pᵢ that is annihilated in the next round:

$$E = {\underbrace{{R}_{1} ∘ {P}_{1}}}_{{OT}_{1}} ∘ {\underbrace{{P}_{1}^{- 1} ∘ {R}_{2} ∘ {P}_{2}}}_{{OT}_{2}} ∘ {P}_{2}^{- 1} ∘ … ∘ {P}_{8} ∘ {\underbrace{{P}_{8}^{- 1} ∘ {R}_{9} ∘ {P}_{9}}}_{{OT}_{9}} ∘ {\underbrace{{P}_{9}^{- 1} ∘ {R}_{10}}}_{{OT}_{10}}$$

AES then becomes a composition of 10 obfuscated tables OTᵢ.

This delinearization step prevents an adversary from viewing the contents of each table. It is then more difficult to extract the keys by inspecting the obfuscated tables OT.

In detail, the obfuscation, illustrated in FIG. 2, works on a byte and each round is composed by four mappings. A mapping may be viewed as a table where ^{r}P_{i,j}(resp. ^{r}Q_{i,j}) is the encoding of a byte using random bijections. ^{r}P_{i,j} and ^{r}Q_{i,j} cancel each other between two consecutive rounds. In other words:

^{r}Q_{i,j}=inv(^{r+1}P_{i,j}) i,j=0, . . . 3

### Billet's Attack

A full description of the attack is found in the paper mentioned hereinbefore. What follows is a simplified description that allows an understanding of the present invention.

Since it is difficult to extract the keys by local inspections of the obfuscated tables, it is more convenient to look at the input and the output of the composition of tables for a round. The attack comprises 5 steps:
1. Recover non-linear parts of all P-boxes and Q-boxes of a round r by analyzing their input and output.
2. Remove P and Q non-linear parts thereby making them unknown affine mappings.
3. Recover the affine mappings.
4. Once the affine mappings are recovered, the bytes of a subkey round (embedded in T-boxes) can be retrieved. The bytes are however in a shuffled order.
5. Repeat step 1 to 4 for the next round r+1. This makes it possible to get another shuffled subkey. Constraints in the AES key schedule algorithm enable retrieving both subkeys in correct order. The AES master key can be recovered knowing only one subkey.

To recover the affine mappings ^{r}Q_{i,j}, it is first necessary to retrieve the affine mappings ^{r}Q_{i,0}=Aᵢ⊕qᵢ, where Aᵢ is linear and qᵢ is a constant. The mappings ^{r}Q_{i,0} for a vector (x,0,0,0) can be written as:

^{r}Q_{i,0}(x,0,0,0)=yᵢ(x,0,0,0)=Aᵢ(α_{i,0}^{r}T_{i,0}(^{r}P_{i,0}(x))⊕^{r}K_{i,0})⊕qᵢ i=0, . . . ,3

where α_{i,0}, with i=0, . . . , 3 are MixColumns coefficients.

This can be rewritten as an x function, and for i=0 this gives:

x [symbol] (S⁻¹∘Λ_{δ}_{ⱼ}∘A₀⁻¹)(y₀(x,0,0,0)⊕cⱼ)=^{r}P_{0,0}(x)⊕^{r}K_{0,0}

where S is the AES S-Box. Λ_{δ} is the matrix over GF(2⁸) of multiplication by δ. (δⱼ, cⱼ) are unknown constants. The value of δⱼ⁻¹ depends on MixColumns coefficients.

$$MC = ( \begin{matrix}{α}_{0 , 0} & {α}_{1 , 0} & {α}_{2 , 0} & {α}_{3 , 0} \\ {α}_{0 , 1} & {α}_{1 , 1} & {α}_{2 , 1} & {α}_{3 , 1} \\ {α}_{0 , 2} & {α}_{1 , 2} & {α}_{2 , 2} & {α}_{3 , 2} \\ {α}_{0 , 3} & {α}_{1 , 3} & {α}_{2 , 3} & {α}_{3 , 3}\end{matrix} ) = ( \begin{matrix}02 & 01 & 01 & 03 \\ 03 & 02 & 01 & 01 \\ 01 & 03 & 02 & 01 \\ 01 & 01 & 03 & 02\end{matrix} )$$

The unique pair (δⱼ, cⱼ) in these mappings can be computed with a time complexity of 2²⁴, provided that the inverse AES S-box and MixColumns coefficients are known. Indeed, given that two of α_{j,0} are 01, the other one is 02 and the last is 03, exactly two of δⱼ⁻¹ are equal. It is thus possible to get Λ_{δj} and then A₀. The constant qᵢ of the affine mapping ^{r}Q_{i,0} can be recovered at the same time.

All ^{r}Q_{i,j} can be recovered thanks to the mappings described above. As ^{r}Q_{i,j}=inv(^{r+1}P_{i,j}), ^{r+1}P_{i,j} is recovered at the same time. The subkey embedded in the T-box can then be extracted.

### SUMMARY OF INVENTION

In a first aspect, the invention is directed to a method for encrypting digital data using an iterative block cipher algorithm that is based on a Feistel network or on a substitution-permutation network. A device receives the digital data and performs a plurality of rounds of alterations on input data, wherein the plurality of rounds comprise a first round and a final round. Each round produces output data, and the input data for the first round is the digital data and the input data for any subsequent round is the output data of the round that precedes the subsequent round. Each round comprises: applying a first transformation function to the round input, wherein the first transformation function is a function that transforms at least one byte state of the round from a first representation to an equivalent cipher representation;

encrypting the round input using the equivalent cipher representation and a key to obtain an encrypted value; and applying a second transformation function to the encrypted value to obtain the output data of the round, the second transformation function being the inverse of the first transformation function. Finally, the round output of the final round is

output.

It will be appreciated that in a symmetrical encryption algorithm, encryption is the same as decryption.

In a first preferred embodiment, the iterative block cipher algorithm is implemented in the device as a white-box implementation.

In a second preferred embodiment, the dual cipher has been randomly chosen from a predefined set of dual ciphers. It is advantageous that the iterative block cipher algorithm is AES and wherein, for at least one round, an S-box non-linear operation has been transformed using the first transformation function. Preferably, for at least one round, at least one of the linear or permutation operation has been transformed using the first transformation function. For at least one round, at least one round: sub-key may have been transformed using the first transformation function; at least one round sub-key may have been obtained from a main key represented in the dual cipher representation; and at least one round sub-key may have been obtained from a main key represented in the dual cipher representation.

In a second aspect, the invention is directed to a device for performing a cryptographic computation on digital data, the cryptographic computation being encryption or decryption performed using an iterative block cipher algorithm based on a Feistel network or on a substitution-permutation network. The device comprises a processor adapted to: receive the digital data and perform a plurality of rounds of alterations on input data, wherein the plurality of rounds comprise a first round and a final round, wherein each round produces output data, and wherein the input data for the first round is the digital data and the input data for any subsequent round is the output data of the round that precedes the subsequent round. Each round comprises: applying a first transformation function to the round input, wherein the first transformation function is a function that transforms at least one byte state of the round from a first representation to an equivalent cipher representation; encrypting the round input using the equivalent cipher representation and a key to obtain an encrypted value; and applying a second transformation function to the encrypted value to obtain the output data of the round, wherein the second transformation function is the inverse of the first transformation function. The round output of the final round is then output.

In a third aspect, the invention is directed to a computer program product storing thereon instructions that, when executed by a processor, performs the method the first aspect.

### BRIEF DESCRIPTION OF DRAWINGS

Preferred features of the present invention will now be described, by way of non-limiting example, with reference to the accompanying drawings, in which

FIG. 1, already described, illustrates a round of prior art before random bijections encoding;

FIG. 2, already described, illustrates obfuscation in White-box AES according to the prior art;

FIG. 3 illustrates dual cipher decryption according to the prior art;

FIG. 4 illustrates one of the four obfuscated mappings in a round according to the first preferred embodiment of the present invention; and

FIG. 5 illustrates a cryptographic device according to a preferred embodiment of the present invention.

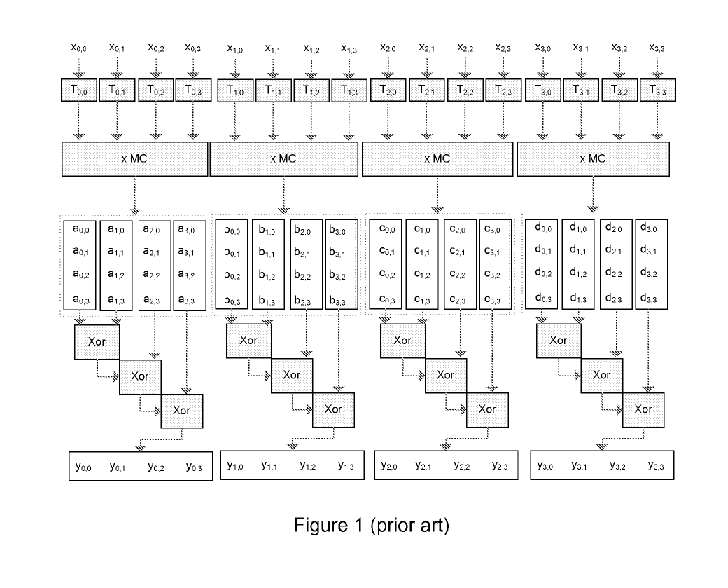

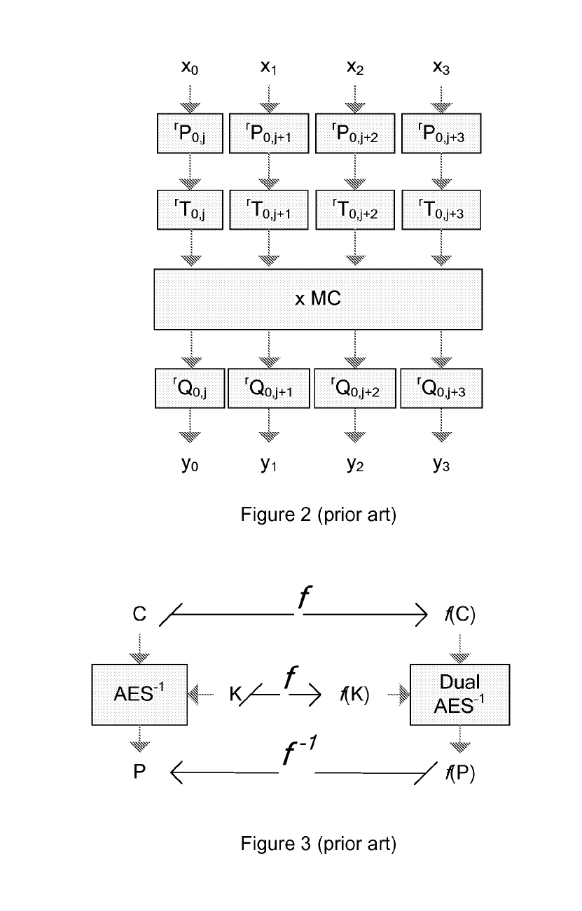

### DESCRIPTION OF EMBODIMENTS

Billet's attack supposes that classical AES constants such as S-box values or MixColumns coefficients are known. In for example the MixColumns matrix, each column consists of the four numbers 01, 01, 02, 03, which is helpful in removing the obfuscations. A main inventive idea of the present invention is thus to make the S-box values and the MixColumns coefficients unknown to the attacker. The present invention can then thwart Billet's attack.

AES is a block cipher system based on simple algebraic operations over the algebraic finite field GF(2⁸). If we replace all the constants in Rijndael—of which AES is a subgroup—including replacement of the irreducible polynomial, coefficients of the MixColumns matrix, and affine transformation in the SubBytes, it is possible to create new dual ciphers of AES. It is mentioned by E. Barkan and E. Biham in “In How Many Ways Can You Write Rijndael?” Asiacrypt 2002, pp. 160-175, 2002, that 240 new dual ciphers of AES can be created. Although the intermediate values of a dual cipher during encryption or decryption are different from those of AES, a dual cipher has a security equivalent to that of AES. While these dual ciphers have been known for quite some time, they have, until now, been regarded as a kind of scientific curiosity without any real practical use.

The outputs of AES and dual AES are also different but correlated, as shown in FIG. 3 that illustrates dual cipher decryption. The correlation means that if P is the plaintext, K is the key, and encryption result (i.e. the ciphertext) with the original AES is C, then encrypting P′=f(P) under the key K′=f(K) using the dual cipher is necessarily f(C). According to this relation, it is possible to construct a white-box using a dual AES instead of the classical AES.

A dual cipher for AES can be created either by modifying original AES constants or by changing the irreducible polynomial. An example of modification of constants is to raise the constants to their second power: affine transformation A.x+b of SubBytes operation is replaced by A².x+b². The polynomial mc(x)=03.x³+01.x²+01.x+02 of MixColumns can be replaced by mc(x)=05.x³+01.x²+01.x+04. There are eight possible modifications for a given irreducible polynomial, they raise constants to power 2, 4, 6, 16, 32, and 64.

The irreducible polynomial in AES is used for the inverse computation in the S-box and also in the multiplication in MixColumns. There are 30 irreducible polynomials in GF(2⁸). Due to the isomorphism of all fields of GF(2⁸), AES can use any of the 30 irreducible polynomials. There are therefore 30*8=240 AES dual ciphers. To be compatible with original AES, the cleartext, the ciphertext and key must be modified trough a linear transformation f. This transforms an AES under an irreducible polynomial to another AES with another polynomial. The transformation is generally represented by a matrix R (f(x)=R.x where x is a vector representation under original AES polynomial). For example, if AES polynomial x⁸+x⁴+x³+x+1 is replaced by x⁸+x₄+x³+x²+1 the invertible matrix R is:

$$R = {R}^{- 1} = [ \begin{matrix}1 & 1 & 1 & 1 & 1 & 1 & 1 & 1 \\ 0 & 1 & 0 & 1 & 0 & 1 & 0 & 1 \\ 0 & 0 & 1 & 1 & 0 & 0 & 1 & 1 \\ 0 & 0 & 0 & 1 & 0 & 0 & 0 & 1 \\ 0 & 0 & 0 & 0 & 1 & 1 & 1 & 1 \\ 0 & 0 & 0 & 0 & 0 & 1 & 0 & 1 \\ 0 & 0 & 0 & 0 & 0 & 0 & 1 & 1 \\ 0 & 0 & 0 & 0 & 0 & 0 & 0 & 1\end{matrix} ] ;$$

The inverse transformation is defined by f¹(y)=R⁻¹.y

The choice of irreducible polynomial in AES is arbitrary and from security perspective there is no advantage of using the original polynomial rather than any other existing polynomial.

To counter Billet's attack, the idea is to choose randomly one of the 240 cipher dual AES to implement instead of the classical AES. This means that the values of the S-box and MixColumns coefficients are not fixed but vary depending on which dual cipher is used.

In a first preferred embodiment, this is implemented by including f in the construction of the T-boxes. Random bijections are next added on top of the newly created T-boxes called _{f}T_{i,j}. As the function ƒ operates on bytes, this gives the following relations:

x←f(x)

_{f}^{r}T_{i,j}(x)=S_{f}(x⊕_{f}^{r}K_{i,j}) r=1, . . . ,9 i,j=0, . . . ,3

_{f}¹⁰T_{i,j}(x)=S_{f}(x⊕_{f}⁹K_{i,j})⊕_{f}¹⁰K_{i,j} i,j=0, . . . ,3

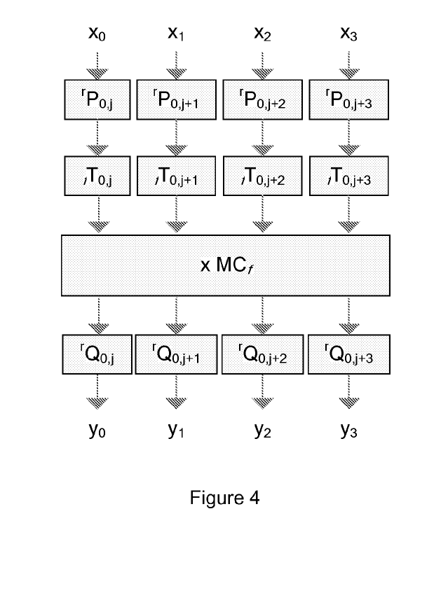

FIG. 4 illustrates one of the four obfuscated mappings in a round according to the first preferred embodiment of the present invention.

In the prior art white-box implementation, i.e. the one provided by Chow et al., the unique pair (δⱼ, cⱼ) can be computed with time complexity of 2²⁴. When a random dual cipher is used, to compute (βⱼ, cⱼ), all 240 possible values of S-box and MixColumns coefficients have to be tested. This raises the complexity to 2³².

While the solution of the first preferred embodiment increases the complexity of the attack, it does not prevent recovery of the AES master key, as the operation in step 5 of the attack still is possible. The second preferred embodiment described hereinafter provides a better countermeasure.

To be more resistant to Billet's attack, it is possible to use a plurality of dual AES and integrate their parameters into the same white-box AES implementation. This may be done using a different dual AES for each round of the encryption process. In the following, a round of a dual AES is called a “dual round”.

As in the first preferred embodiment, a main idea is to choose randomly 10 dual ciphers amongst the 240 available. Let (f₁, f₂, . . . , f₁₀) be the linear transformations associated with the chosen dual AES.

Also, consider AES as a composition of 10 rounds as follows:

E=R₁∘R₂∘ . . . ∘R₉∘R₁₀

The idea is thus to compose 10 dual rounds in the same AES implementation wherein the rounds preferably are different. This may be done by first taking a round operations Rᵢ in each dual cipher E^{(k)}. Let ₖRᵢ be round i of dual cipher E^{(k)}. The idea is to apply a state transformation for a round in the previous round. The mechanism is based on an input-decoding-output-encoding paradigm, performed by applying the inverse transformation of a round output followed by the linear transformation for the input of next dual round. Therefore, both the inverse transformation fₖ⁻¹ and the transformation fₖ₊₁ are applied in round ₖRᵢ:

$$E = {\underbrace{{}_{1}^{}{R}{}_{1}^{} ∘ {f}_{1}^{- 1} ∘ {f}_{2}}}_{{DT}_{1}} ∘ {\underbrace{{}_{2}^{}{R}{}_{2}^{} ∘ {f}_{2}^{- 1} ∘ {f}_{3}}}_{{DT}_{2}} ∘ … ∘ {f}_{9} ∘ {\underbrace{{}_{9}^{}{R}{}_{9}^{} ∘ {f}_{9}^{- 1} ∘ {f}_{10}}}_{{DT}_{9}} ∘ {\underbrace{{}_{10}^{}{R}{}_{10}^{} ∘ {f}_{10}^{- 1}}}_{{DT}_{10}}$$

AES then becomes a composition of 10 dual look-up tables DTᵢ.

The implementation of the white-box is preferably performed by including fₖ in the construction of the T-boxes.

x←f₁(x)

ₖ^{r}T_{i,j}(x)=fₖ₊₁(fₖ⁻¹(Sₖ(x⊕ₖ^{r}K_{i,j}))) r=1, . . . ,9 i,j=0, . . . ,3, k=1

₁₀¹⁰T_{i,j}(x)=f₁₀(f₉⁻¹(S₉(x⊕₉⁹K_{i,j})⊕₁₀¹⁰K_{i,j} i,j=0, . . . ,3

Random bijections are then added on top of the newly created T_{i,j} boxes.

One of the advantages of this solution is that the keys of two consecutive rounds are not correlated. The AES key schedule is based on the S-box value and other constants, and each dual cipher has its own different constants. From the same master key, different subkeys are thus derived for the different dual AES.

Supposing that an attacker manages to guess one dual round, i.e. he knows the S-box and MixColumns coefficients. Then he is able to perform step 1 to step 4 of the attack (with time complexity of at least 2²⁴) and get a shuffled subkey. However, the bytes of a subkey round cannot be reconstructed correctly as the attacker has no way of testing it (since the subkeys of two consecutive rounds are not correlated). To obtain the correct subkey, the attacker has to repeat the attack of Billet twice for all possible combinations of dual ciphers. Billet's attack would hence require at least 2¹⁶ more computation steps and thus the complexity of the entire attack becomes 2⁴⁶.

It has thus been shown how to implement 10 different dual rounds in the same white-box AES. The skilled person will appreciate that it is possible to use even more dual ciphers.

In the following is provided a generalization of the construction that provides a better resistance against the attacks. It has been shown hereinbefore how to implement 10 different dual ciphers in the same white-box implementation. Indeed, the dual cipher was changed at the round level (to ease the description). It is however possible to use even more dual ciphers. Since each 4 byte round output depends only on the 4 byte round input, a different dual AES cipher may be used for each of the four mappings in a round, which means that up to 4*10=40 different dual ciphers can be used in a given white-box AES implementation. If yᵢ is the i-th output byte of round r, then:

y₀,y₄,y₈,y₁₂, depend on x₀,x₁,x₂,x₃

y₁,y₅,y₉,y₁₃, depend on x₄,x₅,x₆,x₇

y₂,y₆,y₁₀,y₁₄, depend on x₈,x₉,x₁₀,x₁₁

y₃,y₇,y₁₁,y₁₅, depend on x₁₂,x₁₃,x₁₄,x₁₅

Without loss of generality, f_{σ}_{₀}^{r}, . . . f_{σ}_{₉}^{r} are the four different transformation matrices associated to the dual ciphers used in round r. As data are shifted (to implement InvShiftRows) as input to type III tables, care should be taken as to which product f×f⁻¹ to combine with which T-boxes of the next round to have the correct input state. The T-boxes were built as follows:

^{r}T_{i,j}(x₄ᵢ₊ⱼ)=f_{σ}_{ᵢ}^{r+1}((f_{σ}_{ⱼ}^{r})⁻¹(Sᵢ^{σ}_{ᵢ}(x₄ᵢ₊ⱼ⊕^{r}K_{i,j)))} r=1, . . . ,9 i,j=0, . . . ,3,

¹⁰T_{i,j}(x₄ᵢ₊ⱼ)=f_{σ}_{ᵢ}¹⁰((f_{σ}_{ᵢ}¹⁰)⁻¹(Sᵢ^{σ}_{ᵢ}(x₄ᵢ₊ⱼ⊕⁹K_{i,j))⊕}¹⁰K_{i,j}i,j=0, . . . ,3

where ^{r}K_{i,j=f}_{σ}_{ᵢ}^{r}(^{r}K_{i,j}), ¹⁰K_{i,j=f}_{σ}_{ᵢ}¹⁰(¹⁰K_{i,j}), Sᵢ^{σ}_{ᵢ} for i=0, . . . ,3 are modified from original SubBytes according to the matrix representing f_{σ}_{ᵢ}^{r} for the round r. It can be noted that the product f_{σ}_{ᵢ}^{r+1}×(f_{σ}_{ᵢ}^{r})⁻¹ changes for each of the 16 tables in a round r, for r in [1.9].

In the case of Billet et al. attack, an attacker would need to put each 4 bytes output in the standard AES state. To do so, he has to check 240⁴ combinations. The complexity for recovering mixing bijections for a round would then be 4*4*2²⁵*2³¹=2⁶⁰. For two rounds, the complexity is bounded by 2⁶¹ computation steps.

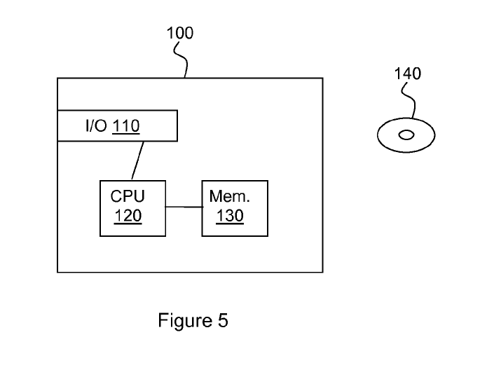

FIG. 5 illustrates a cryptographic device according to a preferred embodiment of the present invention; in other words, the device is adapted to encrypt and decrypt data using any of the encryption algorithms described hereinbefore. The device 100 comprises at least one interface unit 110 adapted for communication with other devices (not shown), at least one processor 120 and at least one memory 130 adapted for storing data. The processor 120 is adapted to perform dual AES cryptographic operations according to any of the first and second embodiments of the inventive methods, as previously described herein. A computer program product 140 such as a CD-ROM or a DVD comprises stored instructions that, when executed by the processor 120, performs the method according to any of the embodiments of the present invention.

It will thus be appreciated that the present invention can offer a white-box AES implementation that is more secure than the prior art solutions. It will also be appreciated that the present invention is limited to neither white-box implementations nor AES, but that other implementations and encryption algorithms may also be used.

While the invention has been described for AES as a non-limitative, preferred example, the skilled person will appreciate that while the invention may also be used in other iterative block cipher encryption algorithms, such as those based on a Feistel network (e.g. DES, IDES, RC5 and IDEA) or, like AES, on a substitution permutation network (e.g. Serpent).

Each feature disclosed in the description and (where appropriate) the claims and drawings may be provided independently or in any appropriate combination. Reference numerals appearing in the claims are by way of illustration only and shall have no limiting effect on the scope of the claims.

1. A method for encrypting digital data using an iterative block cipher algorithm, the iterative block cipher algorithm being based on a Feistel network or on a substitution-permutation network, the method comprising the steps, at a device, of:
receiving the digital data;
performing a plurality of rounds of alterations on input data, wherein the plurality of rounds comprise a first round and a final round, wherein each round produces output data, and wherein the input data for the first round is the digital data and the input data for any subsequent round is the output data of the round that precedes the subsequent round;
wherein each round comprises:
applying a first transformation function to the round input, wherein the first transformation function is a function that transforms at least one byte state of the round from a first representation to an equivalent cipher representation;
applying the first transformation function to at least one round key to obtain an equivalent round key for the equivalent cipher representation;
encrypting the round input using the equivalent cipher representation and the equivalent round key to obtain a round output; and
outputting the round output of the final round.

2. The method of claim 1, further comprising the step of applying an inverse of the first transform to the round output before outputting the round output.

3. The method of claim 1, wherein the equivalent cipher representation has been randomly chosen from a predefined set of equivalent cipher representations.

4. The method of claim 1, wherein, for at least one round, at least one parameter of an affine operation of the first representation has been transformed using the first transformation function.

5. The method of claim 1, wherein, for at least one round, at least one coefficient of a polynomial of the linear operation has been transformed using the first transformation function.

6. The method of claim 3, wherein, for at least one round, at least one round key has been obtained from a main key represented in the equivalent cipher representation.

7. The method of claim 1, wherein the iterative block cipher algorithm is AES.

8. The method of claim 2, wherein the implementation of the block cipher comprises at least one look-up table representing linear or non-linear operations, wherein a transformation using the first transformation function or the second transformation function has been applied to at least one look-up table to obtain a look-up table represented in the equivalent cipher representation.

9. The method of claim 2, wherein the implementation of the block cipher comprises at least one look-up table representing linear or non-linear operation, the at least one look-up tables being obfuscated with some mixing bijection encodings and wherein a transformation using the first transformation function or the second transformation function has been applied to the mixing bijection encodings for the at least one look-up table.

10. A device for performing a cryptographic computation on digital data, the cryptographic computation being encryption or decryption performed using an iterative block cipher algorithm, the iterative block cipher algorithm being based on a Feistel network or on a substitution-permutation network, the device comprising a processor configured to:
receive the digital data;
perform a plurality of rounds of alterations on input data, wherein the plurality of rounds comprise a first round and a final round, wherein each round produces output data, and wherein the input data for the first round is the digital data and the input data for any subsequent round is the output data of the round that precedes the subsequent round;
wherein each round comprises:
applying a first transformation function to the round input, wherein the first transformation function is a function that transforms at least one byte state of the round from a first representation to an equivalent cipher representation;
applying the first transformation function to at least one round key to obtain an equivalent round key for the equivalent cipher representation;
encrypting the round input using the equivalent cipher representation and the equivalent round key to obtain a round output; and
output the round output of the final round.

11. The device of claim 10, wherein the processor is further adapted to apply an inverse of the first transform to the round output before outputting the round output.

12. The device of claim 10, wherein, for at least one round, at least one parameter of an affine operation of the first representation has been transformed using the first transformation function.

13. The device of claim 10, wherein, for at least one round, at least one coefficient of a polynomial of the linear operation has been transformed using the first transformation function.

14. The device of claim 10, wherein the iterative block cipher algorithm is AES.

15. A computer program product 444) storing thereon instructions that, when executed by a processor, performs the method of claim 1.
